(19) United States
(12) Patent Application Publication
(10) Pub. No.: US 2006/0080153 A1
(43) Pub. Date: Apr. 13, 2006

(54) Health care system and method for operating a health care system

(76) Inventors: John L. Fox, Ada, MI (US); Todd J. Osbeck, Grand Rapids, MI (US); Eric A. Richter, Wyoming, MI (US); Brian J. Todey, Ada, MI (US); Diane J. Nicholson, Grand Rapids, MI (US); Diane J. Hopper-Zaenglein, Caledonia, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/961,899

(22) Filed: Oct. 8, 2004

(51) Int. Cl. G06Q 40/00

(52) U.S. Cl. 705/4; 705/2

(57) ABSTRACT

A health care system includes a data warehouse for accumulating data regarding laboratory test results, health care provider claims, pharmacy claims, supplemental information and immunization records. The data is then analyzed by a fact warehouse. The fact warehouse uses rule engines to analyze the data and determine certain facts regarding each participant in the health care system. A health opportunity engine then analyzes the data in light of the determined facts to ascertain whether opportunities exist for providing health care to a participant.

### RELATED APPLICATIONS

This application incorporates by reference an application entitled “DYNAMIC WEB REPORTING TOOL FOR A FACT WAREHOUSE, A FACT CONTAINED WITHIN THE FACT WAREHOUSE, AND A METHOD FOR REFRESHING THE FACT WAREHOUSE” assigned to the assignee of this application, patent application Ser. No ______.

### BACKGROUND OF THE INVENTION

In addition to increasing the wellness of a patient, the full identification and treatment of illnesses is now recognized as ultimately more cost effective than partial treatment. For example, long term and early treatment of hypertension is ultimately less expensive than the treatment of the individual for a stroke caused by the hypertension. Thus, some health care plans give incentives to doctors to prescribe specific treatment for diseases. However, several different providers rather than a single individual most often deliver an individual's health care.

For example, a person may visit a general practitioner for a diagnosis of an illness, a medical laboratory for tests regarding the illness, a specialist for further treatment of the illness, and a pharmacy for drugs to treat the illness. Further, medical treatment may provided to an individual at urgent care clinics, emergency rooms or other places not within the purview of the health care provider. Each of the providers may be a separate organization, and thus have its own unique IT (Information Technology) system.

Thus, information about the treatment received or prescribed to a patient by the various providers may be only sporadically and partially shared. For example, a doctor may write a prescription for medicine but may never know if the person in fact had the prescription filled. A lab test performed by a specialist may never be viewed by a patient's general practitioner.

Providers therefore may be making decisions based upon partial or incomplete information, which may lead to inaccurate or incomplete diagnoses and treatments. Further, some illnesses are best detected by focusing on the totality of treatment provided to an individual rather than on a single episodic complaint.

At the same time, providers are not always aware of a patient's unmet health care needs, including cancer prevention (e.g., mammography) or chronic disease progression (e.g., cholesterol monitoring).

A system and process for providing aggregated and integrated complete information to providers as well as suggesting treatment alternatives as well an incentive system for encouraging such treatment is thus highly desirable.

### BRIEF DESCRIPTION OF THE DRAWINGS

FIG. 1 shows a computer network.

FIG. 2 shows an information flow diagram for the information.

FIG. 3 shows a home screen for a web interface.

FIG. 4 shows a health condition search page.

FIG. 5 shows a diabetes health condition criteria page.

FIG. 6 shows an asthma health condition criteria page.

FIG. 7 shows a cardiovascular condition criteria page,

FIG. 8 shows a pediatric preventive health criteria page.

FIG. 9 shows an adult preventive health criteria page.

FIG. 10 shows a patient selection screen

FIG. 11 shows a patient information detail screen

FIG. 12 shows a prescription information detail screen

FIG. 13 shows a clinical alert detail screen.

FIG. 14 shows a supplemental information entry screen

FIG. 15 shows a patient search page.

FIG. 16 shows a flow chart for operation of the system

### DETAILED DESCRIPTION OF THE DRAWINGS

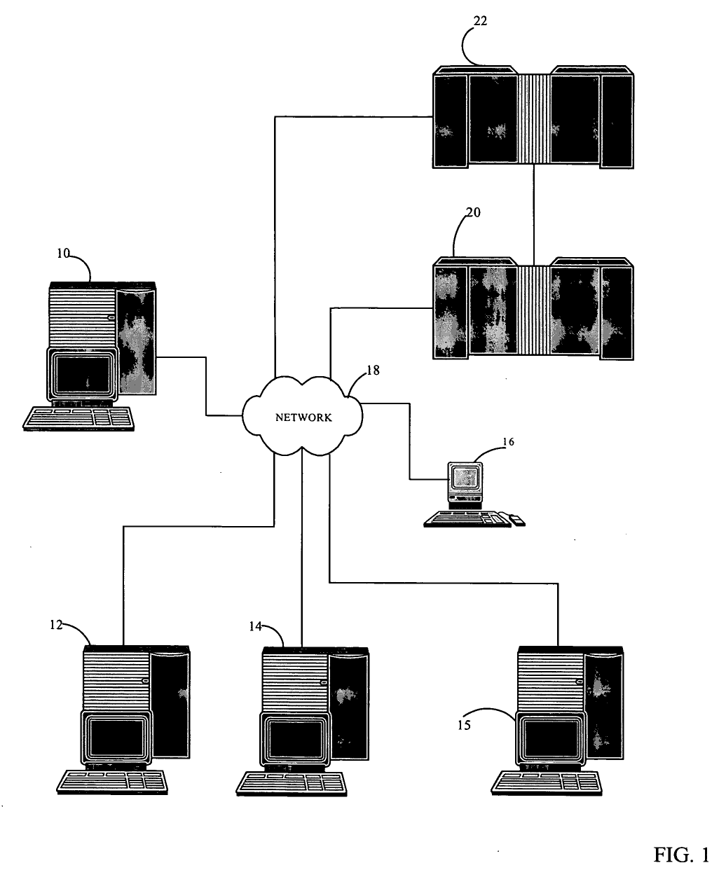

FIG. 1 shows a computer network. Each computer shown in FIG. 1 has a memory, a processor, a mass storage device, and a communication interface. Provider claims computer 10 provides claim information to data warehouse computer 20 by way of network 18. Provider claims computer 10 is used to process claims for payment by a provider of medical services to a participant in a health insurance plan. For example, a physician who performed services for a participant would submit a claim for payment for those services to a health insurance provider.

The claim by the provider contains information about the type of services rendered to the participant. For example, the information contained in the provider's claim would include the date of the services rendered and the type of services rendered to the participant as well as the diagnosis. The claim is submitted to provider claims computer 10. The claim data is then transmitted to data warehouse computer 20.

Similarly, lab claim computer 12 manages the claims for payment submitted by medical test facilities to the health insurance company. The claims for payment submitted to lab claim computer 12 could include the date, type and results of any medical tests performed upon a participant.

Pharmacy claims computer 14 receives claims from a pharmacy for medications provided to a participant. Pharmacy claims submitted to pharmacy claims computer 14 include the date the medications were provided to the participant as well as the type of medication dispensed. Immunization computer 15 contains a registry of immunization provided to participants by agencies, such as schools.

Provider computer 16 is connected to network 18. Provider computer 16 can be used by a provider of medical services such as a physician to supply supplemental information to data warehouse computer 20. For example, a physician might provide clarification regarding a participant's medical condition in addition to the information contained within a claim for reimbursement.

The data submitted by computers 10, 12, 14, 15 is captured within data warehouse 20. Data warehouse computer 20 is connected to fact warehouse computer 22. Facts are determined from the data within data warehouse computer 20 and are made available to provider computer 16.

The various computers of FIG. 1 are shown as stand alone machines. As can be easily appreciated by one familiar with computer systems, some tasks could be performed by a single machine performing several different functions at one time. Further, while data warehouse 20 and fact warehouse 22 are shown as separate machines, both could be combined into a single computer.

As is well known to those familiar with data communications, the various devices shown in FIG. 1 communicate over network 18 by encoded electrical signals. The various communications between the devices are encoded on carrier waves by communication transceivers within each of the devices and then decoded by similar transceivers at the destination of the communications.

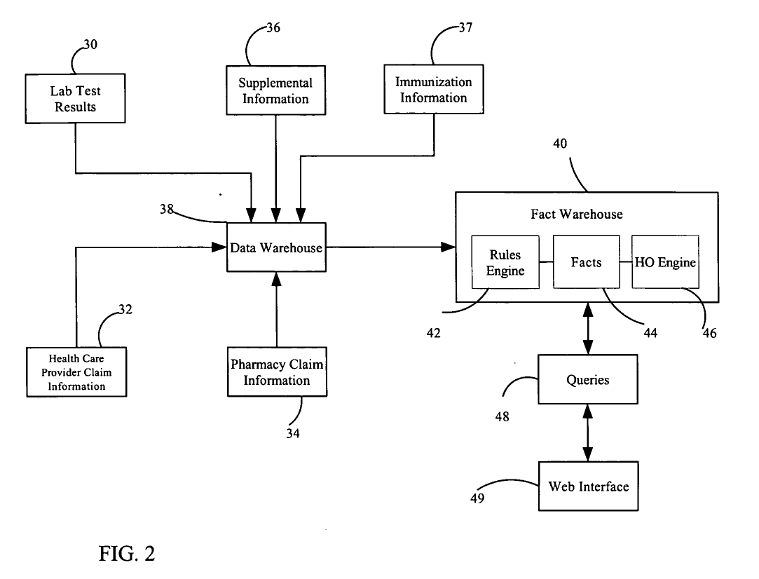

FIG. 2 shows an information flow diagram for the information. Lab test results 30, health care provider information 32, pharmacy claims information 34, and supplemental information 36 is submitted to data warehouse 38. Additionally, immunization records 37 from, e.g., the Michigan Childhood Immunization Registry, could also be provided to data warehouse 38.

Data stored in data warehouse 38 represents the raw information provided from the various information sources. Data from data warehouse 38 is provided to fact warehouse 40.

Fact warehouse 40 includes rules engine 42, facts 44, and health opportunity engine 46. Rules engine 42 interprets data provided by data warehouse 38 to produce facts 44.

Rules engine 42 could assign points for each indicator of a medical condition. A medical claim submission, a prescription for a medicine to treat hypertension, and laboratory test results for hypertension are all indicators that a participant has hypertension. Each would be assigned a point value. The sum of the point values would then be used by the system to determine whether a participant did have hypertension for the purposes of the invention described herein. For example, one kind of rules engine would define diabetes-related offices visits with a primary care physician and counting how may visits occurred in the last twelve months as well as the date of the most recent visit.

Health opportunity engine 46 examines facts 44 and determines whether health opportunities for specific participants are available. A health opportunity is a proactive step by a participant or a provider to improve the health of a participant. For example, current health practices encourage that a diabetic have a lipid test every twelve months. For each diabetic participant, health opportunity engine 46 examines whether she had a lipid test within the past twelve months. If not, the health opportunity engine indicates that a health opportunity for a lipid test exists for this particular participant.

Queries 48 could then be made against the fact warehouse 40 to obtain access to its contents. Queries 48 are accessed through web interface 49.

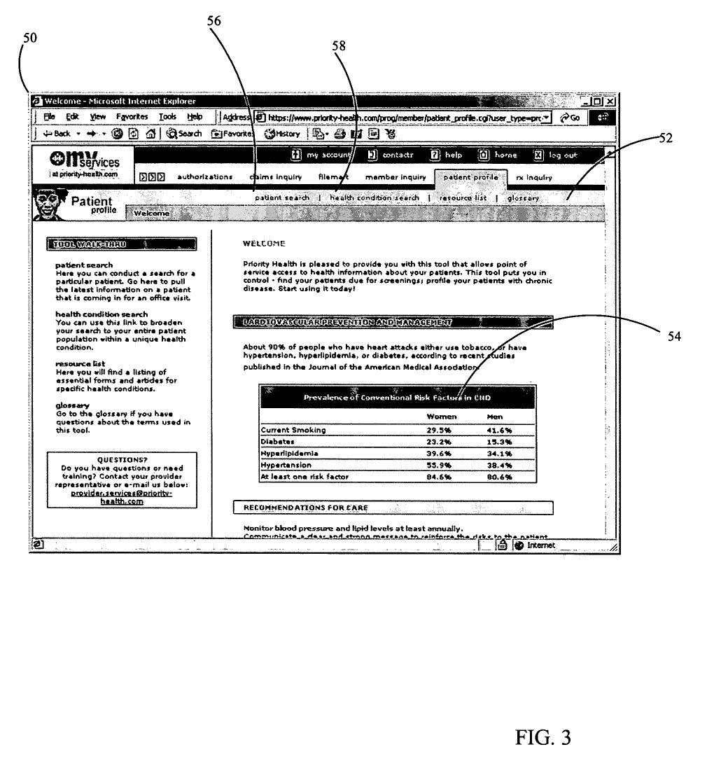

FIG. 3 shows a home screen 50 for web interface 49. Obviously, web interface 49 is accessible only after a user has been authenticated as a valid user.

Home screen 50 includes navigation bar 52. Navigation bar 52 allows a provider access to the features of web interface 44. Current topic area 54 provides information of general interest to a provider.

Navigation bar 52 includes patient search link 56, health condition search link 58, resource link list 60, and glossary link 62.

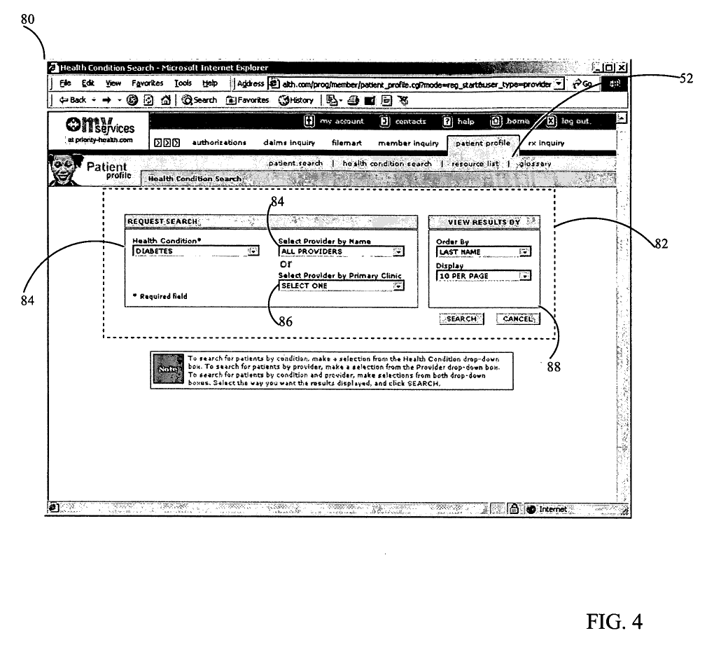

FIG. 4 shows health condition search page 80 which is accessed from navigation bar 52. Health condition search criteria 82 allow a provider to select various search terms. Health condition 84 is a drop-down menu of various health conditions, such as, for example, diabetes, asthma, and depression. Provider search criteria 84 allow a user to select one of several providers, assuming the user has sufficient authorization to search for more than one provider. Alternatively, the search can be based upon the primary clinic using clinic search criteria 86. Sort criteria 88 provide various ways to sort the retrieved information.

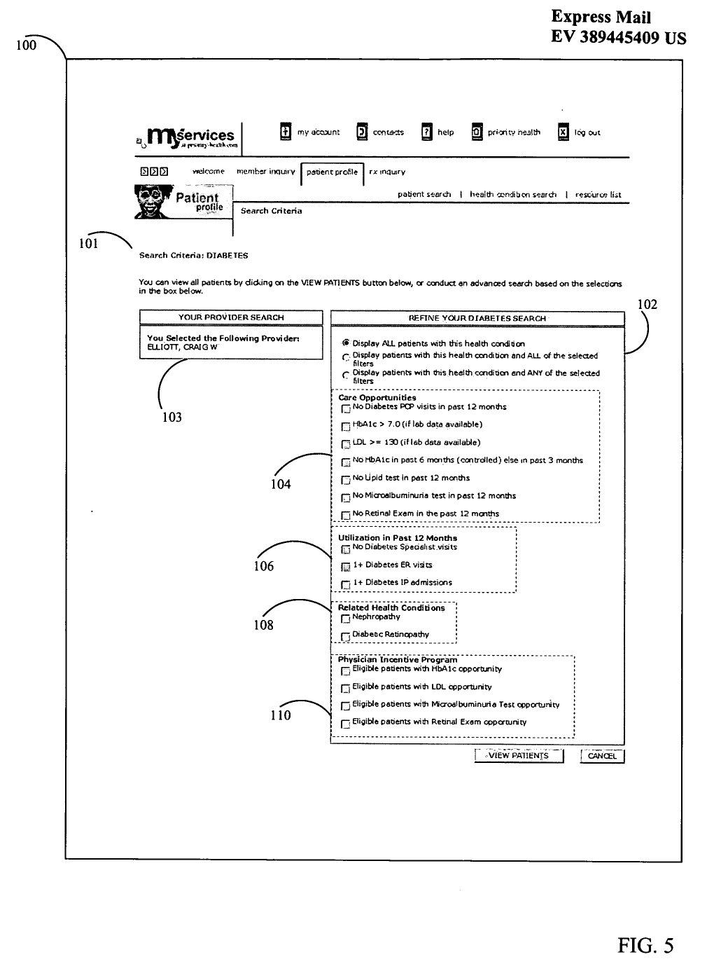

After selection of the criteria and initiation of a search from health condition search page 80, a provider is given an opportunity to further refine the by way of diabetes health condition criteria page 100, shown in FIG. 5. The first level search criteria are displayed by way of boxes 101 and 103.

Health condition refinement selection 102 allows a provider to further refine the search for participants according to a number of different criteria. Health care opportunities search criteria 104 allows searching for participants with specific health care opportunities to perform preventive and chronic disease health care. For example, the search could be limited to those individuals with diabetes who have not had a lipid test within the past twelve months. Services utilization search criteria 106 allow a search for participants who have used, or not used, specific services within the past twelve months. Relation health condition search criteria 108 allows a search to cross-reference participants with related illnesses.

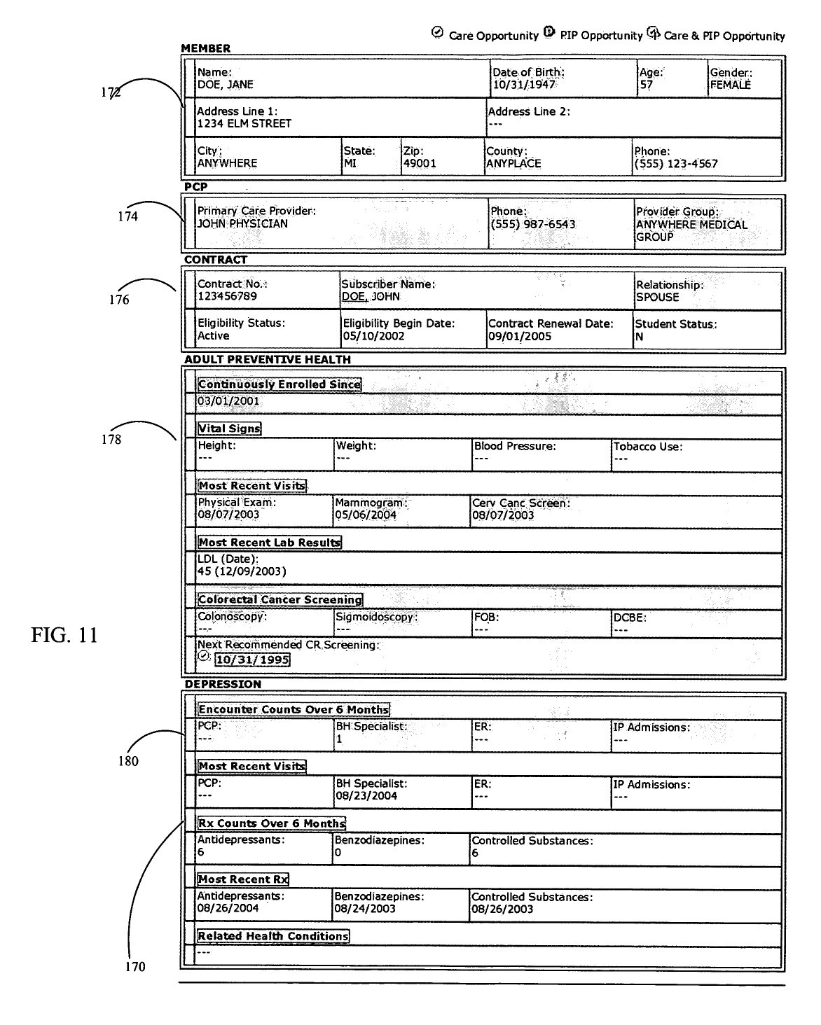

Physician incentive program search criteria 110 allows a provider to search for participants where an opportunity for the physician to receive an incentive exists. That is, some health care plans encourage physicians to perform preventive health care for a participant by providing financial incentives to physicians to perform specific tasks. Physician incentive program search criteria 110 allows a physician to view records for those participants where a financial incentive may be awarded if the participant uses a specific service. All patients meeting the selection criteria chose by the user are shown. The participant name hyperlinks to the patient detail screen, shown later as FIG. 11.

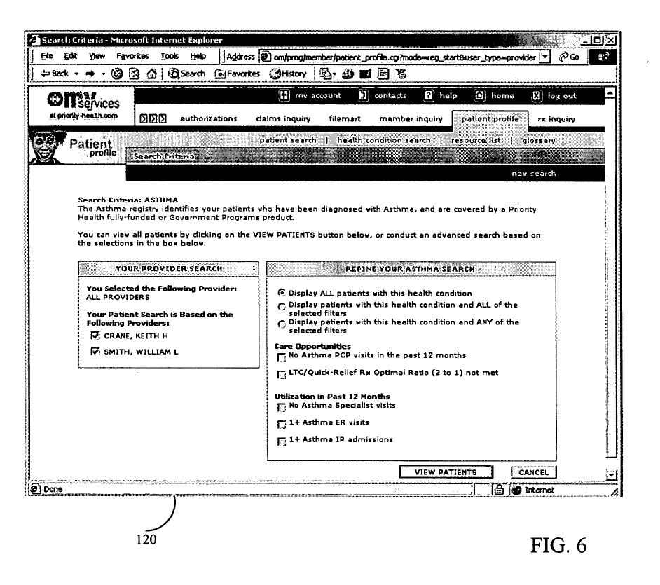

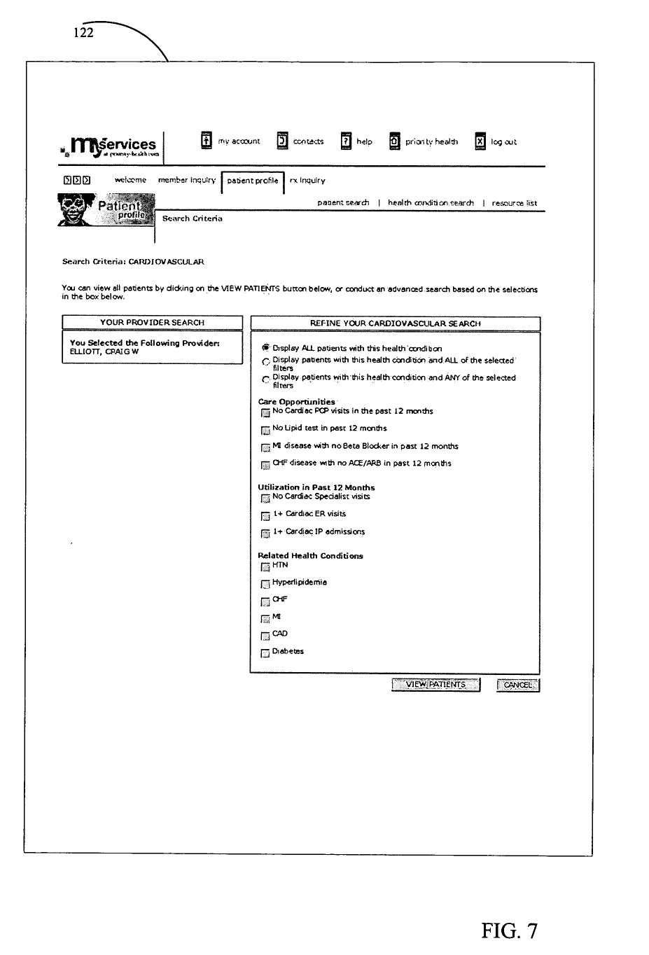

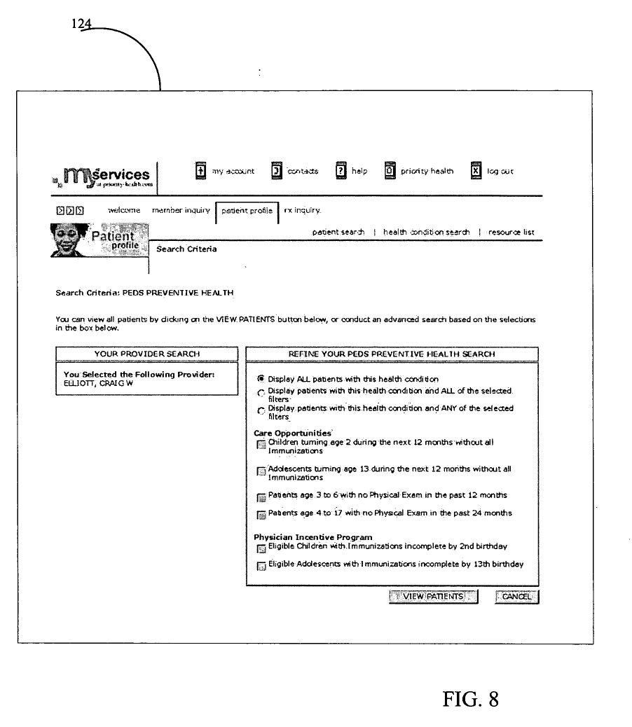

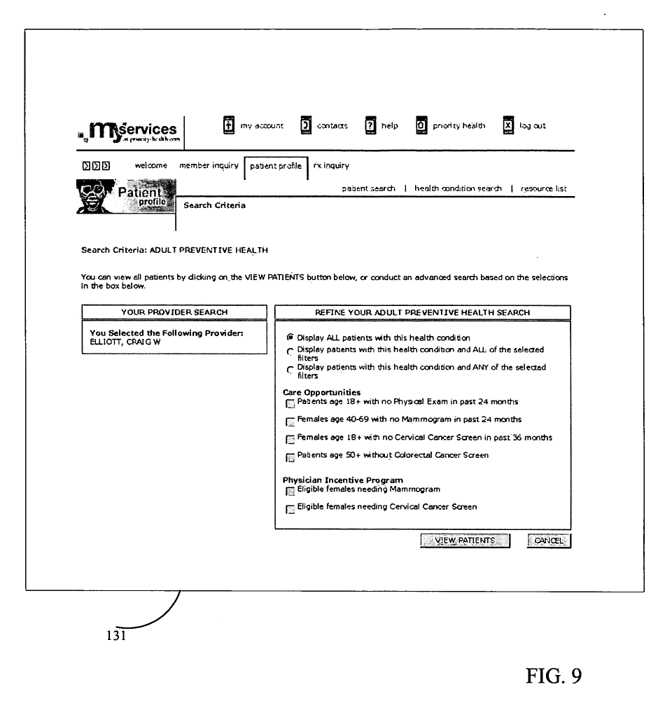

FIG. 6 shows asthma health condition criteria page 120. FIG. 7 shows cardiovascular condition criteria page 122. FIG. 8 shows pediatric preventive health criteria page 124. FIG. 9 shows adult preventive health criteria page 126. The health condition criteria pages shown in FIG. 6, FIG. 7, FIG. 8 and FIG. 9 are similarly arranged as the one shown in FIG. 5.

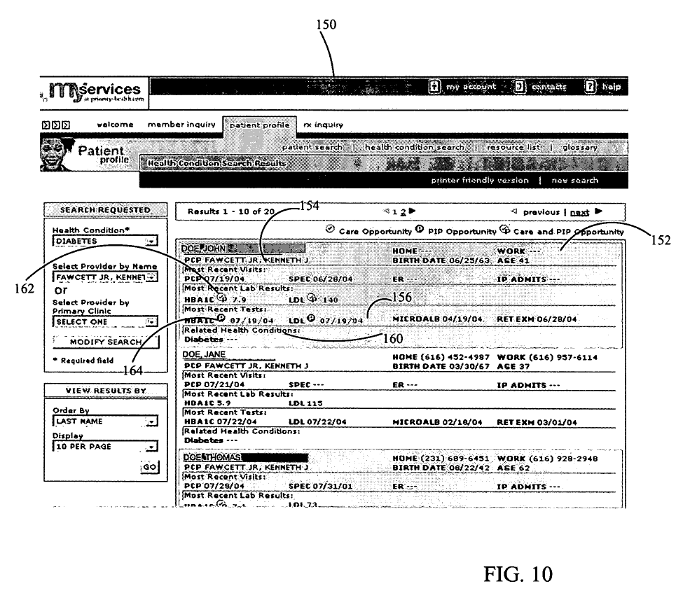

FIG. 10 shows patient selection screen 150 after a search has been conducted using the one of the health condition criteria pages shown in FIGS. 5, 6, 7, 8, or 9. For each participant, general biographic information 152 is shown, as well as most recent visits 154, most recent tests 156, and related health conditions 160. Information such as the most recent prescriptions filled could also be shown.

Health care opportunities 162 are shown with an indicator, such as a check mark indicating whether a care opportunity currently exists and whether a care opportunity will occur in a calendar year. Additionally, health care opportunities 162 and physician incentive program opportunities 164 could be highlighted or presented in a color different from that of the rest of the page. Provider incentive opportunities 164 show an opportunity for a provider to receive a financial incentive if the health care opportunity is performed.

FIG. 11 shows a patient information detail screen 170. Patient information detail screen 170 shows general biographical information 172, primary care physician information 174, contract information 176, preventive health information 178 and illness detail information 180. Preventive health information 178 details information regarding a participants general health such as vital signs, most recent visits to the physician, most recent lab results and screening results. Illness detail information 180 shows information regarding any specific illness for the participant. Any health care opportunities for the participant are highlighted.

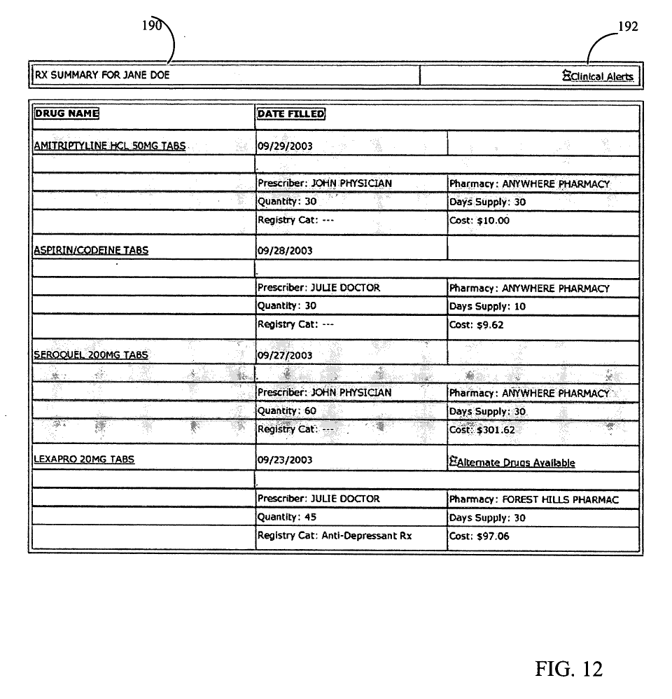

FIG. 12 shows a prescription information detail screen 190. For each drug prescription filled for a particular participant, a summary of that prescription is displayed which includes the date the prescription was filled, the physician prescribing the medication, the pharmacy filling the prescription, and the cost for filling the prescription.

Clinical alert 192 is displayed whenever a problem or discrepancy is detected by rules engine 42. By clicking on clinical alert 192, more detailed information is shown.

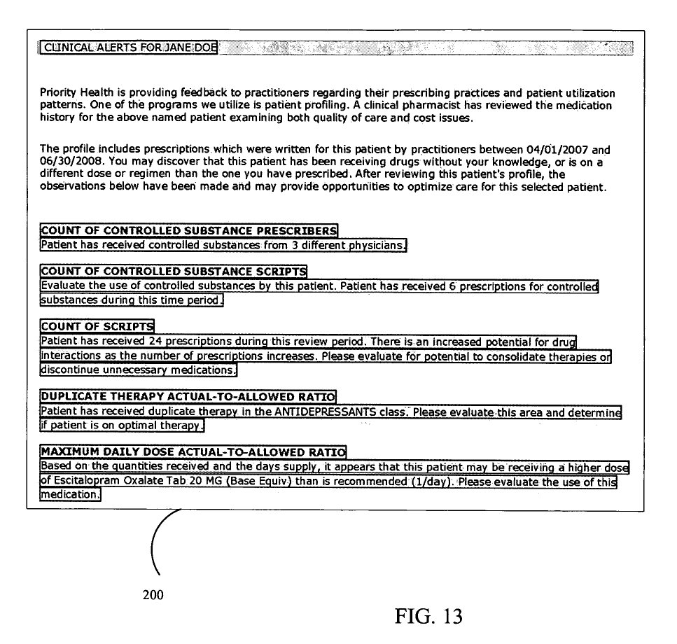

FIG. 13 shows more clinical alert detail 200 regarding clinical alert 192 of FIG. 12. A detailed explanation of the clinical alert is provided.

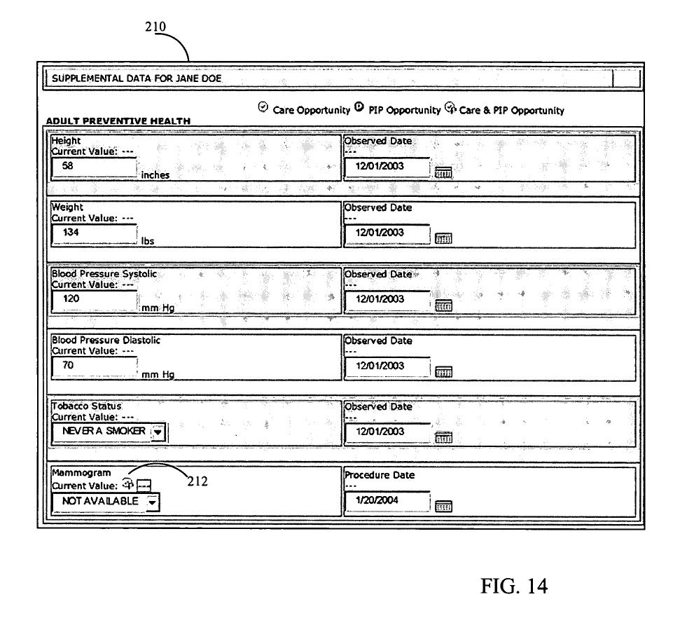

FIG. 14 shows supplemental information entry screen 210. A provider can enter supplemental information regarding a participant. Obviously, many different types of supplemental information can be entered such as height, weight, blood pressure, colon screening, and mammograms. Mammogram entry 212 is associated with a health opportunity and is therefore highlighted.

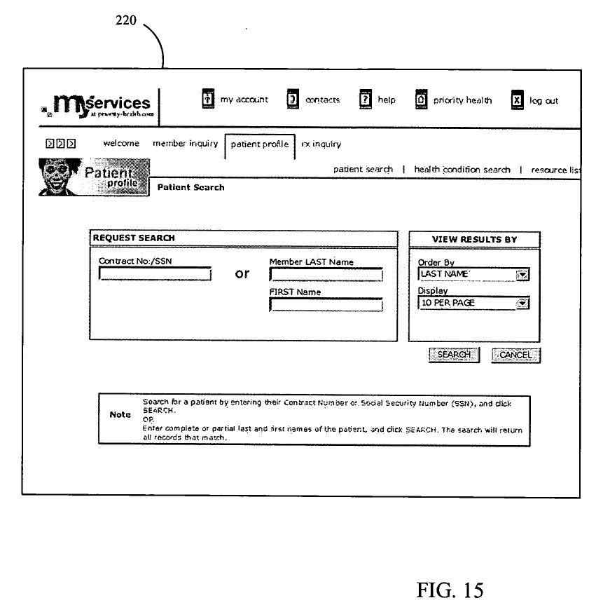

FIG. 15 shows patient search page 220. A provider can access a patient's profile directly if information such as name and social security number is known.

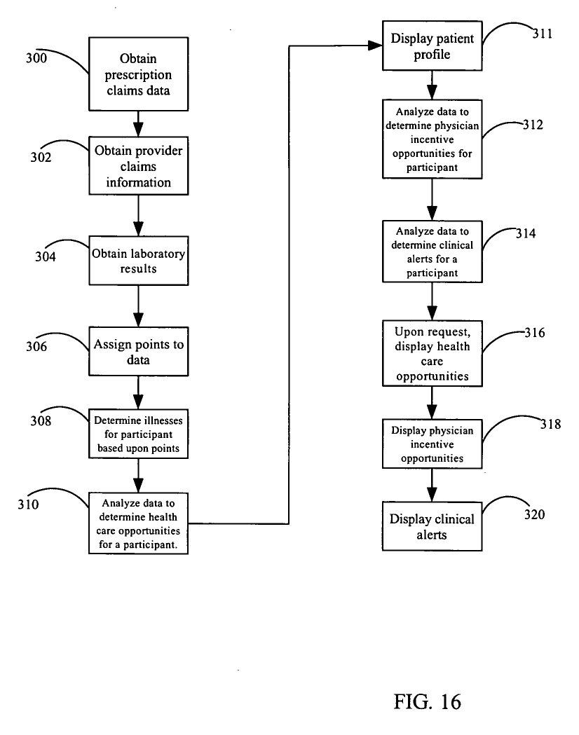

FIG. 16 shows a flow chart for operation of the system. Prescription claims information is obtained. Step 300. Provider claims information is also obtain, Step 302, as are lab results. Step 304. Based upon this information, points are assigned to the data. Step 306. Illnesses are then determined for each participant. Step 308. After illnesses are determined, then the data is again analyzed to determine health care opportunities (step 310), physician incentive opportunities (step 312) and clinical alerts (step 314). Upon request, the health profile for a participant is displayed. Step 311. Similarly, upon request, the system displays health care opportunities (step 316), physician incentive opportunities (step 318), and clinical alerts (step 320).

A health care opportunity or physician incentive opportunity is determined by first determining from the various information sources whether a participant has an illness. That is, claim information, supplemental information and the other available information is examined to ascertain whether the participant has an illness. If the person is found to have an illness, then the patient's health care activities for a given time frame are examined. Within that time frame, certain health care practices should have been followed. For example, a participant with diabetes should have had a lipid test within the previous twelve months. For each preferred health care practice for the illness, the system determines whether than particular health care practice was in fact performed or met within the desired time frame. Again, with reference to the lipid test, the system searches the facts for claims information indicating whether a lipid test was in fact performed. If not, then an indicator is set for that participant so that a health care provider when viewing a fact summary for that individual will see that the particular health care practice was not fulfilled.

In some instances, the health care practice may be tied to a financial incentive for a health care provider. For example, a health care provider could be given a financial incentive if all or a percentage of her patients with a particular disease has all or a percentage of the preferred health care practices for a particular illness met within a period of time (e.g., a year). In this manner, the health care of a participant is optimized so that the participant enjoys a significantly improved health.

Encouragement of health care providers to have the health care practices of the participants is further enhanced by allowing the health care provider to see a list of patients with health care practices deemed deficient, giving the health care provider the opportunity to proactively enhance the health care of the participants.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A method of operating a health care system comprising:
collecting claim information;
determining from the claim information whether a participant in the health care system has an illness; and
analyzing the claim information to determine if a health opportunity exists.

2. The method of claim 1 further comprising:
analyzing the claim information to determine if a clinical alert exists.

3. The method of claim 2 further comprising:
analyzing the claim information to determine if a physician incentive opportunity exists.

4. The method of claim 3 further comprising:
displaying the health opportunity to a health care provider.

5. The method of claim 4 further comprising:
collecting laboratory test results; and
using the laboratory test results to assist in determining whether a participant in the health care system has an illness.

6. The method of claim 5 further comprising:
collecting supplemental information from the health care provider; and
using the supplemental information to assist in determining whether a participant in the health care system has an illness.

7. The method of claim 6 further comprising:
collecting pharmacy claim information; and
using the pharmacy claim information to assist in determining whether a participant in the health care system has an illness.

8. The method of claim 7 further comprising:
assigning a point value to at least some of the claim information;
adding the point values to form a cumulative total; and
using the cumulative total to determine whether a participant has an illness.

9. A health care system comprising:
a data warehouse for maintaining claim information;
a rules engine for determining from the claim information whether a participant has an illness; and
a health opportunity engine for determining from the claim information whether a health opportunity exists.

10. The health care system of claim 9 further comprising:
a facts warehouse for maintaining facts derived from the claim information.

11. The health care system of claim 10 further comprising:
a pharmacy claims computer coupled for submitting pharmacy claims.

12. The health care system of claim 11 further comprising:
a laboratory test results computer coupled for submitting laboratory test results.

13. The health care system of claim 12 further comprising:
a supplemental information computer for submitting supplemental information.

14. The health care system of claim 13 further comprising:
query manger for handling queries to the fact warehouse.

15. The health care system of claim 14 further comprising:
a web interface for accessing information within the fact warehouse.

16. A display for information regarding a participant in a health care system comprising:
a health care opportunity, the health care opportunity derived from claim information.

17. The display of claim 16 further comprising:
a physician incentive opportunity area.

18. The display of claim 18 further comprising:
a clinical alert area.

19. The display of claim 18 further comprising:
a biographical information are about the participant.

20. The display of claim 19 further comprising:
a primary care provider area.

21. The display of claim 20 further comprising:
a laboratory test result are.

22. The display of claim 21 further comprising:
a participant illness information area having information regarding an illness of the participant.

23. The display of claim 22 further comprising:
a prescription information area having information regarding medications purchased by the participant.

24. A method of operating a health care system, the health care system having a data warehouse containing information about participants in the health care system, each participant having a primary care provider, comprising:
searching the data warehouse for participants having a first primary care provider to generate a first primary care provider participant list;
identifying in the first primary care provider list those participants having a health care opportunity; and
displaying the participants having a health care opportunity to the primary care provider.

25. The method of claim 24 further comprising:
searching the data warehouse for participants having a provider incentive opportunity.

26. The method of claim 25 further comprising:
identifying in the first primary care provider list those participants having a provider incentive opportunity.

27. The method of claim 26 further comprising:
displaying to the primary care provider the participants having a provider incentive opportunity.

28. The method of claim 27 further comprising:
searching the data warehouse for participants having a clinical alert.

29. The method of claim 28 further comprising:
identifying in the first primary care provider list those participants having a clinical alert.

30. The method of claim 29 further comprising:
displaying to the primary care provider the participants having a clinical alert.
